(19) United States
(12) Patent Application Publication
(10) Pub. No.: US 2017/0365160 A1
(43) Pub. Date: Dec. 21, 2017

(54) Emergency Wearable Smart Device

(71) Applicants: Lisa Aurbach, Morganville, NJ (US); Trevor Mesnik, North Las Vegas, NV (US)

(72) Inventors: Lisa Aurbach, Morganville, NJ (US); Trevor Mesnik, North Las Vegas, NV (US)

(21) Appl. No.: 15/626,035

(22) Filed: Jun. 16, 2017

Related U.S. Application Data
(60) Provisional application No. 62/351,168, filed on Jun. 16, 2016.
(60) Provisional application No. 62/351,168, filed on Jun. 16, 2016.

(51) Int. Cl. G08B 25/01; G08B 25/10

(52) U.S. Cl. CPC G08B 25/016; G08B 25/10

(57) ABSTRACT

Disclosed is an emergency wearable smart device. The emergency wearable smart device allows for a user to quickly notify a plurality of contacts in the event an emergency situation is encountered. In the event of an emergency the user can trigger an alarm with the push of a button. The Alarm will either activate a High Decibel Alarm and/or a Silent Alarm. Simultaneously the alarm will trigger information to be sent to a predetermined list of contacts containing one or more of the following pieces of information: Position information, messages, audio and video stream, and other information to be relayed to the contacts on a continual basis. In the event that the alarm is triggered the alarm may be configured to continue until such point as it is terminated by the user, or optionally a predetermined amount of time has passed, or optionally when an administrator of the Server ends the emergency notification routine.

### PRIORITY

This application claims the benefit of U.S. Provisional Application No. 62/351,168, filed Jun. 16, 2016.

### BACKGROUND

Various methods and tools exist to alert of the existence of an emergency. The tools which exist range from things that are meant to notify people in the immediate area of the emergency to tools which are meant to notify people who are not immediately in the vicinity of the emergency. These tools exist in various shapes and sizes and allow for things from simple audio alarms to more complex location-based notifications.

In many current emergency notification systems the size of the device can be prohibitive to continuous transport in many locations or can prove inappropriate in certain social situations. Additionally, many of the existing systems lack the ability to cohesively notify a group of people about an ongoing emergency that the user has encountered.

For the foregoing reasons, there is a need for an emergency notification system which is both encompassing of differing emergency situations and compact enough to be transported without providing a hindrance to the user.

### SUMMARY

The present invention is directed to a device which allows for alerting one or more contacts about a potential emergency situation. The device allows for a user to trigger an alarm condition which thereby initiates a series of notifications that have been previously configured by the user. The notifications can include an audible alarm, a text message, a voice message, a video stream, an audio stream, an e-mail message, location information, or any other type of electronically transmitted message. The notifications typically occur simultaneously.

### BRIEF DESCRIPTION OF DRAWINGS

FIG. 1 is a flow chart of an emergency notification routine in accordance with the invention.

FIG. 2 is a block diagram of an emergency wearable smart device in accordance with the invention.

FIG. 3 is an expanded flow chart of an emergency notification routine in accordance with the invention.

FIG. 4 is a perspective view of an emergency wearable device in accordance with the invention showing a physical emergency notification routine button.

### DESCRIPTION OF DRAWINGS

The accompanying drawings, which are incorporated in and constitute a part of the specification, illustrate a presently preferred embodiment and a presently preferred method of the invention. These drawings, together with the general description given above and the detailed description of the preferred embodiment and method given below, serve to explain the principles of the invention.

Although embodiments of the present invention have been described in considerable detail with reference to certain preferred versions thereof other versions are possible. For example, an embodiment of the invention contained herein shows all of the notification components and the database components contained on one server but the components could be on multiple servers. Therefore, the spirit and scope of this application should not be limited to the description of the preferred versions contained herein.

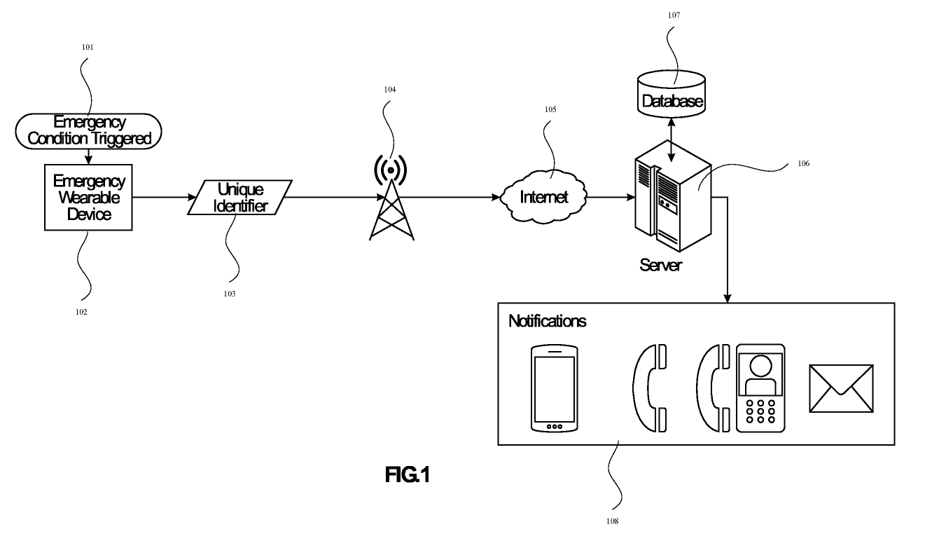

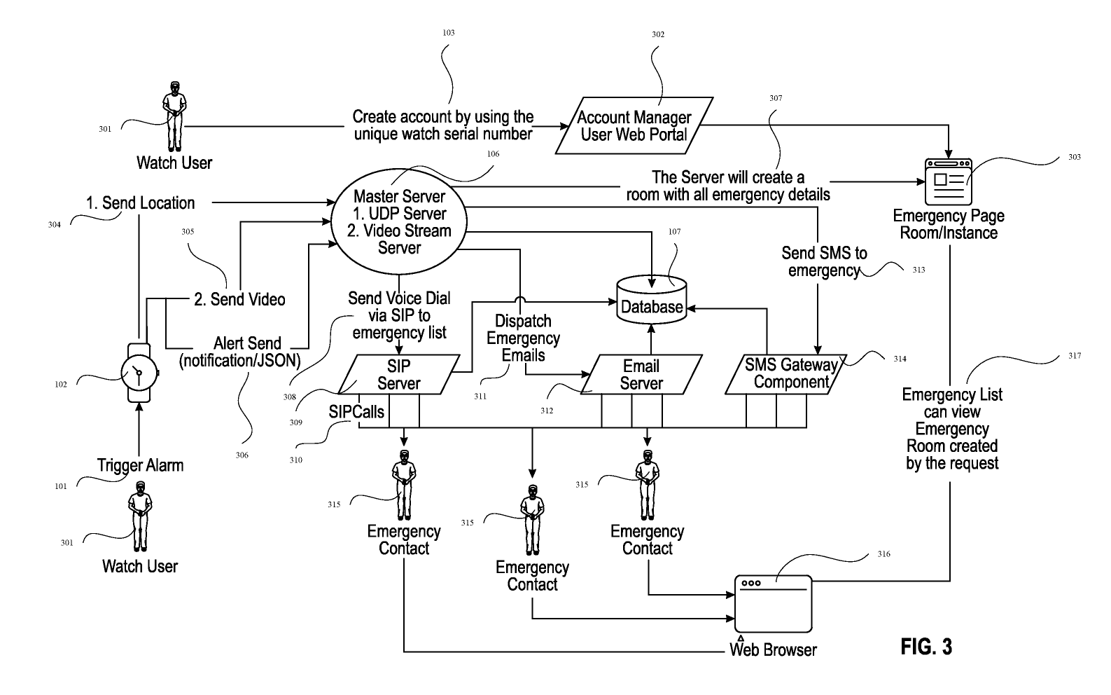

Description of the invention will now be given with reference to FIG. 1-4. One embodiment of the emergency notification routine of the invention is shown in FIG. 1 and another is shown in FIG. 3.

An embodiment of the emergency notification routine (emergency notification mechanism) is shown in FIG. 1. Once an Emergency Condition is triggered 101 on the Emergency Wearable Device 102, a Unique Identifier 103 is sent wirelessly to an External Receiver 104. The External Receiver 104 then relays the information to the Internet 105. The information traverses the internet and is transmitted to a Server 106. The Server 106, searches a Database 107 for contact information and for notifications required and delivers the Notifications 108. The notifications can be of any of the types mentioned in the Description or similar types.

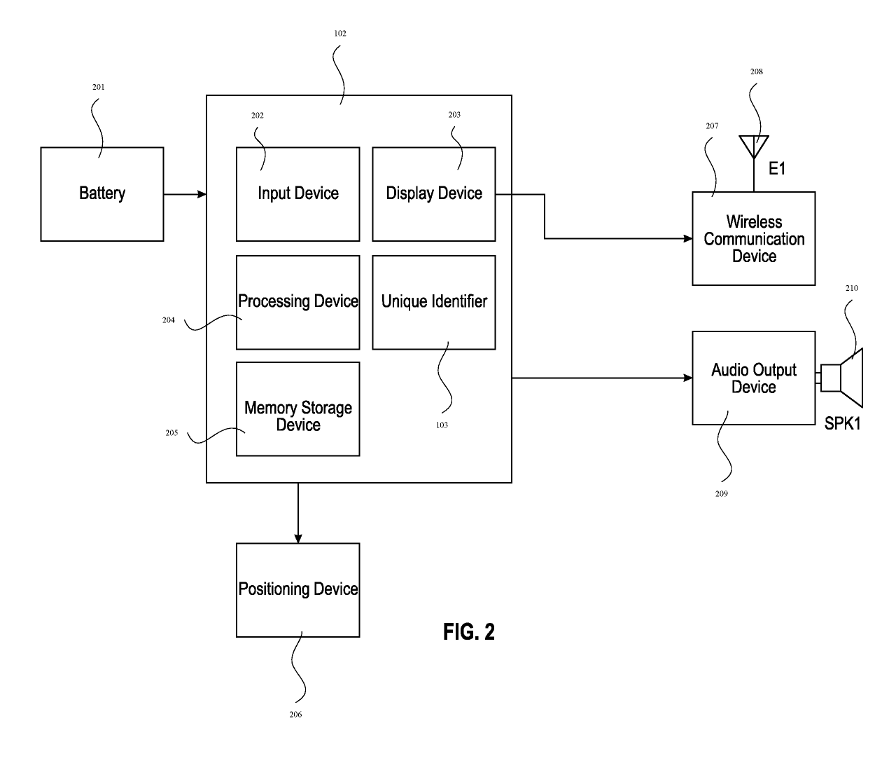

An embodiment of the emergency wearable device is shown in FIG. 2. The Emergency Wearable Device 102 has a Unique Identifier 103, a Battery 201, an Input Device 202, a Display Device 203, a Processing Device 204, a Memory Storage Device 205, a Positioning Device 206, a Wireless Communication Device 207 attached to an Antenna 208, an Audio Output Device 209, and a Speaker 210. The Battery 201 is connected to each of the other components electronically which provides the power necessary for the Emergency Wearable Device, 102. The Memory Storage Device 205 is used to store information about the Emergency Wearable Device 102, including but not limited to the operating system and required carrier and emergency notification functions. The Speaker 210 can be used in conjunction with the Audio Output Device 209 to alert the surrounding area of an emergency situation. The Input Device 202 is used to trigger an emergency notification routine which transmits, as required, the location gathered from the Positioning Device 206 through the Antenna 208 by utilizing the Wireless Communication Device 207. The Processing Device 204 is used to complete any required tasks necessary for the emergency wearable device, as described herein, to function.

A alternative embodiment of the emergency notification routine (emergency notification mechanism) is shown in FIG. 3. A User 301 can create an account by using the Unique Identifier 103, through an Account Manager User Web Portal 302. The User 301 can enter desired contact information and can view the Emergency Room Web Page 303 for the Emergency Wearable Device 102. The emergency notification routine is triggered by a User 301, the User 301 triggers an alarm 101 on the Emergency Wearable Device 102. The Emergency Wearable Device 102 then sends the location information 304 and optionally Sends Video or audio 305, and an Alert 306 to a Server 106. The Server pulls information from a Database 107 to determine which notifications need to be sent which were previously inputted by the User 301. The Server 106 creates an Emergency Room Webpage 307. The Server 106 sends any required notifications through a Voice Communication Request 308 to a Voice Communication Server 309 which then any required Voice Communication is initiated 310. The Server also sends any required E-mail Communication Request 311 to an E-mail Communication Server 312 which sends required messaged. The Server additionally sends any required Text (SMS/MMS) Message Request 313 to a Text (SMS/MMS) Message Server 314 which relays the required Text (SMS/MMS) Message Request

Any required Voice Communication Request 308, E-mail Communication Request 311 or Text (SMS/MMS) Message Request 313 is sent to a plurality of Emergency Contacts 315. The Emergency Contacts 315 are sent information necessary to view a live Web Browser 316, limited to the Emergency Contact List 317, containing the Emergency Room Web Page 303. The Device 102 periodically updates the position, audio, and video information contained on the Emergency Room Web Page 303 when the Emergency Notification Routine has been triggered. In the event that an emergency has not been triggered, the Device 102 periodically updates position information to the Server 106.

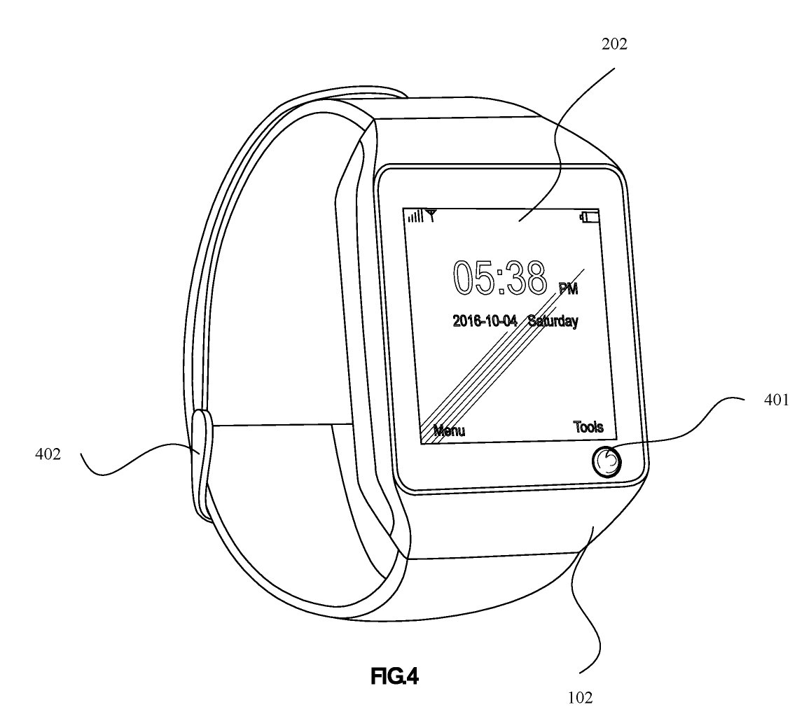

An embodiment of a perspective view of an emergency wearable device is shown in FIG. 4. The Emergency Wearable Device 102 has a Output and Input Device 202 and allows the Emergency Notification Routine to be triggered by a physical button, the Emergency Button 401. The Emergency Wearable Device 102 is secured to a user by a Device Connector 402.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features which service the same, equivalent or similar purpose, unless expressly stated otherwise. Thus, unless expressly stated otherwise, each feature disclosed is one example only of a generic series of equivalent or similar features.

### Description

A preferred embodiment of the device includes a wearable device which includes a display device, a means for affixing the device to a wearer, an input device, a processing device, a battery, a wireless communication device, a memory storage device, a speaker, and a positioning system such as a GPS compatible receiver. The wearable device connects to a general purpose computing system which allows for commands from the device to be processed. The general purpose computing system connects to a series of services which allow for the sending of text messages (SMS messages), voice calls, video calls, e-mail, and other types of electronic messages. The wearable device has a unique identifier which can be used to track settings for the wearable device.

The user of the wearable device enters contact information, and the types of notifications which are to be received, into a database which is contained on the general purpose computing system or on another similar computing system, the server. The server tracks the contact information for the notification parties by the unique identifier of the wearable device. In addition to storing user related information the server is responsible for initiating any communications which are requested through the wearable device.

The wearable device allows a user to press a button, either a physical button or a button contained on a touchscreen device, which triggers an emergency notification routine. The emergency notification routine provides the specified type of notification or types of notifications which have been stored on the server for the notification parties. In a preferred embodiment of the device, optionally once the emergency notification routine has been triggered, it continues until the user wearing the wearable device enters a disarm code on the device, or optionally a predetermined amount of time has passed, or optionally when an administrator of the Server ends the emergency notification routine. The disarm code is stored on the device itself and is set by the user at a time prior to activating the emergency notification routine.

An embodiment of the emergency notification routine completes the following steps. When the unique wearable device identifier is provided by the wearable device to the server along with a request to trigger the emergency notification routine, the server checks to see which parties are contained within the notification parties list contained within the database. The server then determines which type of notification should be sent to each notification party. The server then provides the information specific for each type of notification to each contact on the notification parties list.

There are several potential types of notifications which can be sent to each notification party. The database can be configured to send any or all of the following notification types, including optionally the amount of time until the alarm is disabled. The first type of the notification is a text message which utilizes either a direct connection to the SMS network or a gateway to the network which allows for sending a predetermined message which has been entered by the user of the wearable device prior to activating the emergency notification routine. The predetermined message may also contain one or more of the following pieces of information: the location of the wearable device, the time at which the emergency notification routine was initiated, the identifying information for the wearable device (including the device owner), the bearing at which the device is travelling, and the current speed at which the device is moving. The next type of notification system is e-mail; the server can be configured to use an e-mail gateway or can connect directly to e-mail servers in order to deliver messages. The e-mail notification can contain each of the pieces of information contained within the text message notifications. An additional potential type of notification is the video notification which allows information to be sent to notification parties to allow for viewing of contemporaneously transmitted video and audio which is sent from the wearable device to the server, this utilizes any of several video transmission systems which are available. An additional potential notification system is the voice notification system. The voice notification system is connected either directly to the public telephone system or through a voice over IP gateway which allows telephone calls to be completed. The voice notification system is capable of playing a prerecording message to a notification party along with providing the additional information which can be included in the text message and e-mail notification systems, the voice notification system may also be configured to transmit the audio portion of video notification system and as such can be contemporaneously transmitted as it is recorded.

An alternative embodiment of the present invention provides a system wherein the battery level of the wearable device is monitored and if it reaches a predetermined level additional non-emergency related features of the wearable device are disabled in order to conserve battery which can be configured by the user or disabled completely.

An alternative embodiment of the present invention provides a silent alarm feature which silences the alarm on the wearable device itself, and hides any indication of an alarm condition, but continues to notify the notification parties of the ongoing emergency.

In the Summary above and in the sections below, and in the accompanying drawings, reference is made to particular features of the invention. It is so understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined}. For example “at least 1” means 1 or more than 1. The term “at most” followed by a number is used herein to denote the end of a range ending with that number (which may be a range having 1 or 0 as its lower limit, or a range having no lower limit, depending upon the variable then being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper it is 100 mm.

The invention does not require that all of the advantageous features and all the advantages need to be incorporated into every embodiment of the invention.

What is claimed is:

1. A wearable device for providing an emergency location comprising: a battery, an input device, a display device, a unique identifier, a processing device, a memory storage device, a positioning device, a wireless communication device, an antenna, an audio output device, and a speaker; said input device, said display device, said processing device, said memory storage device, said positioning device, said wireless communication device, and said audio output device being electronically connected; said speaker being electronically connected to said audio output device; said wireless communication device being electronically connected to said antenna; said device further also comprising a housing with a device connector attached to said housing, said device connector allows for the device to be removably attached to a user; said device further also comprising an emergency notification mechanism, said emergency notification mechanism when triggered transmits positioning information obtained from said positioning device and the unique identifier through said antenna via the wireless communications device to an external receiver; said emergency notification mechanism is triggered by the user, once the positioning information is transmitted to the external receiver it is relayed to a server, the server communicates with a database of emergency contact information which is determined by the unique identifier of said device, the emergency contact information contains the required information to contact a plurality of emergency contacts and the method of communication requested, the emergency contact information is used to deliver a plurality of emergency notifications to a plurality of emergency contacts.

2. A wearable device according to claim 1 wherein said housing is constructed of a non-metallic material.

3. A wearable device according to claim 1 wherein said housing is constructed of a metallic material.

4. A wearable device according to claim 1 wherein said emergency notification mechanism further comprises a repetitive audible alert through said speaker.

5. A wearable device according to claim 1 wherein said emergency notification mechanism is triggered by a physical button adapted for that purpose.

6. A wearable device according to claim 1 wherein said display device is adapted to allow for input from the user.

7. A wearable device according to claim 6 wherein said emergency notification mechanism is triggered by the user interacting with said display device.

8. A wearable device according to claim 6 wherein said emergency notification mechanism further comprises a repetitive audible alert through said speaker.

9. A wearable device according to claim 8 wherein said repetitive audible alert continues until a disarm sequence is entered by the user.

10. A wearable device according to claim 8 wherein said repetitive audible alert continues until a predetermined amount of time has passed.

11. A wearable device according to claim 8 wherein said repetitive audible alert continues until disabled on said Server.

12. A wearable device according to claim 1 wherein said wearable device is a wrist watch.

13. A wearable device according to claim 2 wherein said wearable device is a wrist watch.

14. A wearable device according to claim 3 wherein said wearable device is a wrist watch.

15. A wearable device according to claim 4 wherein said wearable device is a wrist watch.

16. A wearable device according to claim 5 wherein said wearable device is a wrist watch.

17. A wearable device according to claim 6 wherein said wearable device is a wrist watch.

18. A wearable device according to claim 7 wherein said wearable device is a wrist watch.

19. A wearable device according to claim 8 wherein said wearable device is a wrist watch.

20. A wearable device according to claim 9 wherein said wearable device is a wrist watch.

21. A wearable device according to claim 1 wherein said wearable device further comprises a video capture device which can be triggered by said emergency notification mechanism.

22. A wearable device according to claim 1 wherein said wearable device further comprises an audio capture device which can be triggered by said emergency notification mechanism.
